(19) United States
(12) Patent Application Publication
(10) Pub. No.: US 2023/0206007 A1
(43) Pub. Date: Jun. 29, 2023

(54) METHOD FOR MINING CONVERSATION CONTENT AND METHOD FOR GENERATING CONVERSATION CONTENT EVALUATION MODEL

(71) Applicant: BEIJING BAIDU NETCOM SCIENCE TECHNOLOGY CO., LTD., Beijing (CN)

(72) Inventors: Kun LIU, Beijing (CN); Kai LIU, Beijing (CN)

(21) Appl. No.: 18/179,521

(22) Filed: Mar. 7, 2023

(30) Foreign Application Priority Data
May 27, 2022 (CN) 202210591004.6

(51) Int. Cl. G06F 40/30; G06F 16/332; G06F 16/335; G06F 16/35

(52) U.S. Cl. CPC G06F 40/30; G06F 16/35; G06F 16/335; G06F 16/3329

(57) ABSTRACT

In a method for mining a conversation content, conversation to be mined is obtained. The conversation to be mined includes a platform conversation content. A user profile and a product profile corresponding to the conversation to be mined are obtained. The conversation to be mined is divided into a plurality types of semantic units. Clustered platform conversation contents are generated by clustering the platform conversation content based on intents of the platform conversation content corresponding to the plurality types of semantic units, the user profile and the product profile. Intents of the platform conversation content corresponding to the same type of semantic units are the same or similar. A target conversation content in the clustered platform conversation contents is determined based on the clustered platform conversation contents and a conversation content evaluation model.

### CROSS-REFERENCE TO RELATED APPLICATION

This application claims priority to Chinese Application No. 202210591004.6, filed on May 27, 2022, the entire disclosure of which is incorporated herein by reference.

### TECHNICAL FIELD

The disclosure relates to a field of artificial intelligence technologies, in particular to fields of deep learning, data processing, and natural language processing technologies, and further to a method for mining conversation content and a method for generating a conversation content evaluation model.

### BACKGROUND

Currently, in the conversation content mining scenario, the communication records of excellent staff are transcribed into text through Automatic Speech Recognition (ASR) service specially optimized for the product industry communication scenario, the speech portion of the staff and the speech portion of the customer in the records are separated, and sentences with similar semantics can be found by a special clustering algorithm. At last, the best practice conversation content of excellent staff are summarized in combination with business experience.

### SUMMARY

According to the first aspect of the disclosure, a method for mining conversation content is provided. The method includes: obtaining a conversation to be mined, in which the conversation to be mined includes a platform conversation content; obtaining a user profile and a product profile corresponding to the conversation to be mined; dividing the conversation to be mined into a plurality types of semantic units; generating clustered platform conversation contents by clustering the platform conversation content based on intents of the platform conversation content corresponding to the plurality types of semantic units, the user profile and the product profile, in which the intents of the platform conversation content corresponding to the same type of semantic units are the same or similar; and determining a target conversation content in the clustered platform conversation contents based on the clustered platform conversation contents and a conversation content evaluation model.

According to the second aspect of the disclosure, a method for generating a conversation content evaluation model is provided. The method includes: obtaining sample conversations, in which the sample conversations include respective platform conversation contents; obtaining respective user profiles and respective product profiles corresponding to the sample conversations; for each sample conversation, dividing the sample conversation into a plurality types of semantic units; for each sample conversation, generating clustered platform conversation contents by clustering the platform conversation content corresponding to the sample conversation based on intents of the platform conversation content corresponding to the plurality types of semantic units, the respective user profile and the respective product profile, in which the intents of the platform conversation content corresponding to the same type of semantic types are the same or similar; and generating the conversation content evaluation model by training a conversation content evaluation model to be trained based on the clustered platform conversation contents of the sample conversations and respective actual conversation content evaluation results of the clustered platform conversation contents.

According to the third aspect of the disclosure, an electronic device is provided. The electronic device includes: at least one processor and a memory communicatively connected to the at least one processor. The memory stores instructions executable by the at least one processor, when the instructions are executed by the at least one processor, the at least one processor is caused to implement the method for mining conversation content according to the first aspect of the disclosure or the method for generating a conversation content evaluation model according to the second aspect of the disclosure.

It is understandable that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a flowchart illustrating a method for mining conversation content according to a first embodiment of the disclosure.

FIG. 2 is a schematic diagram illustrating a conversation to be mined.

FIG. 3 is a schematic diagram illustrating a user profile.

FIG. 4 is a schematic diagram illustrating a product profile.

FIG. 5 is a schematic diagram illustrating a target conversation content.

FIG. 6 is a flowchart illustrating a method for mining conversation content according to a second embodiment of the disclosure.

FIG. 7 is a flowchart illustrating a method for generating a conversation content evaluation model according to the first embodiment of the disclosure.

FIG. 8 is a block diagram illustrating an apparatus for mining conversation content according to the first embodiment of the disclosure.

FIG. 9 is a block diagram illustrating an apparatus for mining conversation content according to the second embodiment of the disclosure.

FIG. 10 is a block diagram illustrating an apparatus for generating a conversation content evaluation model according to the first embodiment of the disclosure.

FIG. 11 is a block diagram illustrating an apparatus for generating a conversation content evaluation model according to the second embodiment of the disclosure.

FIG. 12 is a block diagram illustrating an electronic device for implementing the method for mining conversation content according to an embodiment of the disclosure.

### DETAILED DESCRIPTION

The following describes the embodiments of the disclosure with reference to the accompanying drawings, which includes various details of the embodiments of the disclosure to facilitate understanding, which shall be considered as merely examples. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

Artificial intelligence (AI) is a technical science that studies and develops theories, methods, technologies and application systems for simulating, extending and expanding human intelligence. Currently, AI technology has the advantages of high automation, high accuracy and low cost, and has been widely used.

Deep Learning (DL), as a new research direction in the field of Machine Learning (ML), learns the intrinsic laws and representation levels of sample data, and the information obtained from these learning processes can be of great help in the interpretation of data such as text, images, and sounds. Its ultimate goal is to enable machines to have the same analytical learning capabilities as human, to recognize data such as text, images and sound. In terms of specific research content, it mainly includes neural network systems based on convolutional operations, i.e., convolutional neural networks; self-coding neural networks based on multilayer neurons; and deep belief networks that are pre-trained in the form of multilayer self-coding neural networks and then combined with authentication information to further optimize neural network weights. DL has yielded many achievements in the fields of search technology, data mining, ML, machine translation, natural language processing, multimedia learning, speech, recommendation and personalization techniques, and other related fields. DL has caused machines to imitate human activities such as seeing, hearing and thinking, which solves many complex pattern recognition challenges and enables significant advances in AI-related technologies.

Data Processing (DP) refers to the collection, storage, retrieval, processing, transformation and transmission of data. The basic purpose of DP is to extract and derive data that is valuable and meaningful to certain specific people from a large amount of possibly-disorganized and incomprehensible data. DP is a fundamental part of system engineering and automatic control. DP presents in all areas of social production and social life. The development of data processing technology and the breadth and depth of its applications have greatly influenced the development of human society.

Natural Language Processing (NLP) is the study of computer system that can effectively implement natural language communication, especially the software system therein, and is an important direction in the fields of computer science and artificial intelligence.

In the related art, the process of mining conversation content is time-consuming and has high labor costs, and the accuracy of the result of mining conversation content is average and not highly applicable to practical application scenarios, which leads to low work efficiency.

Therefore, a method for mining conversation content, an apparatus for mining conversation content, a system, a terminal, an electronic device and a medium of the embodiments of the disclosure are described below in combination with the accompanying drawings.

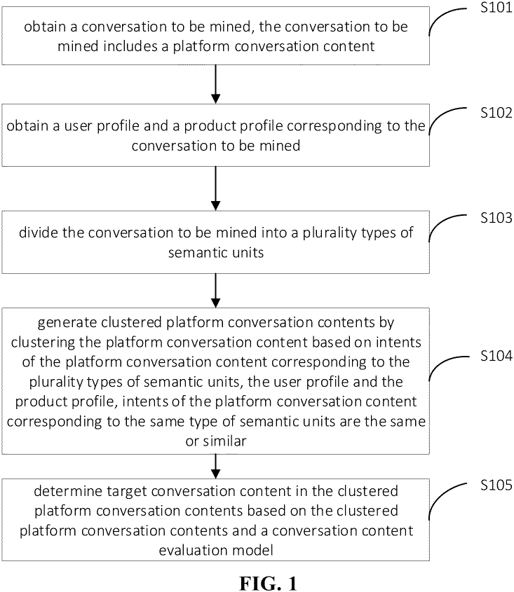

FIG. 1 is a flowchart illustrating a method for mining conversation content according to a first embodiment of the disclosure.

As illustrated in FIG. 1, the method for mining conversation content according to the embodiments of the disclosure includes the following.

At step S101, a conversation to be mined is obtained. The conversation to be mined includes a platform conversation content provided by a platform.

The execution subject of the method for mining conversation content according to embodiments of the disclosure may be an apparatus for mining conversation content according to an embodiment of the disclosure, which may be a hardware device having data information processing capabilities and/or the software necessary to drive the hardware device to operate, which may be referred to as a multi-tenant management service in the disclosure. For example, the execution subject may include a workstation, a server, a computer, a user terminal and other devices. The user terminal includes, but is not limited to, a mobile phone, a computer, a smart speech interaction device, a smart home appliance, and a vehicle terminal.

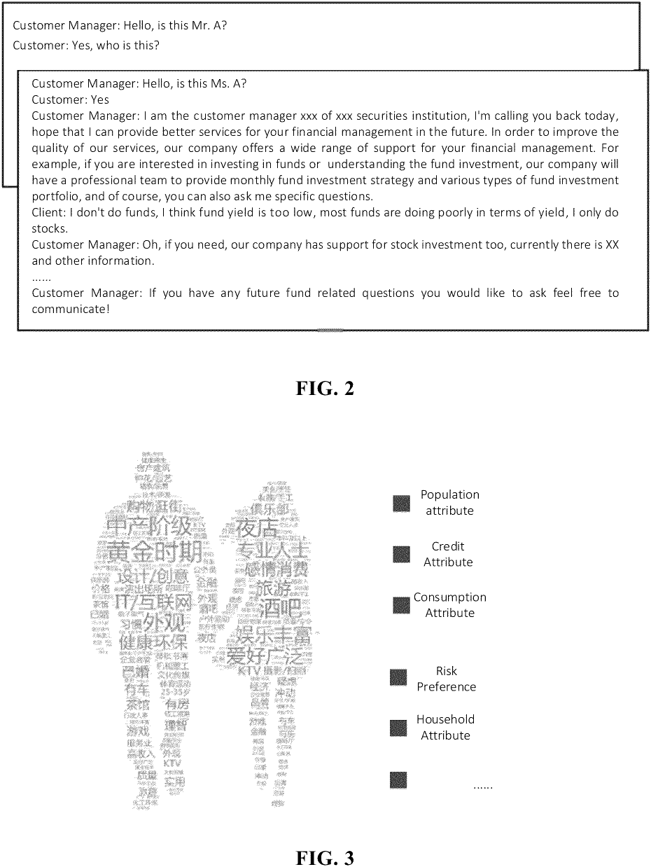

As illustrated in FIG. 2, the above mentioned “platform” is a platform for providing conversation services, such as a customer service platform. The above mentioned “conversation to be mined” (also referred as “session to be mined”) is a platform conversation record from which a conversation content is to be mined. The “platform conversation content” is an appropriate communication expression provided by the platform for different customers, different products and different needs of customers to facilitate smooth push of the product to the customer, and the conversation to be mined includes the platform conversation content. The conversation to be mined is obtained for subsequent processing. For example, the conversation to be mined can be obtained from the conversation log session of the platform.

It is noteworthy that the platform conversation content includes an active conversation content and a passive conversation content. The active dialogue content refers to the conversation content generated by the platform in actively conducting the communication session with the user and acquiring the real needs of the user. The passive conversation content refers to feedback provided by the platform in response to common problems and objections from the user in actual communication. For example, the conversation record between the platform and the user can be divided into several conversation stages including, such as, a greeting stage, a self-introduction stage, a product/business introduction stage, a stage of answering the questions and doubts concerned by the user and guiding the user (also referred to as an answering and guiding stage), and a final conclusion stage. Among these communication stages, the conversation contents generated in the greeting stage, the self-introduction stage and the final conclusion stage all belong to the active conversation content, while the conversation content generated in the answering and guiding stage belongs to the passive conversation content.

At step S102, a user profile and a product profile corresponding to the conversation to be mined are obtained.

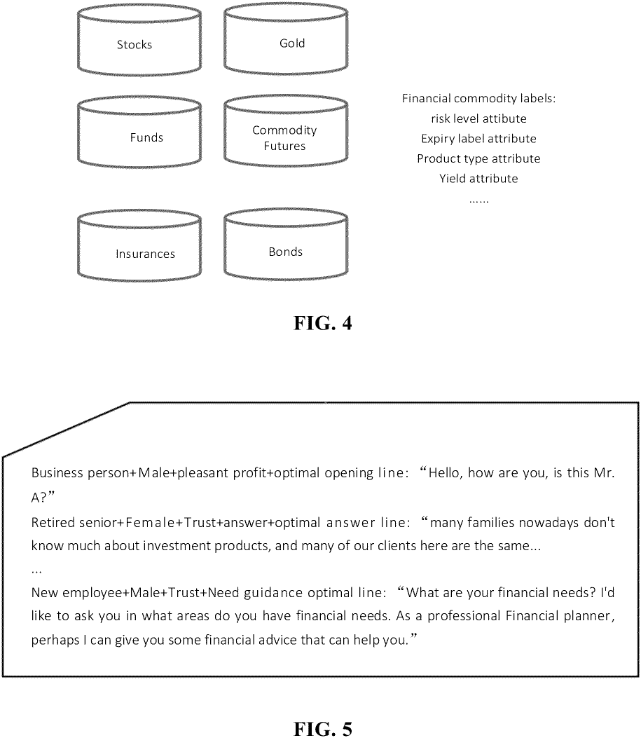

In embodiments of the disclosure, the user profile and the product profile corresponding to the conversation to be mined that is obtained at step S101 are obtained for subsequent processing. It is noteworthy that each conversation between the platform and the user relates to two basic elements, i.e., the customer and the corresponding product. The user profile is a system of product-oriented multidimensional attribute labels of the user, in which specific attribute values are given for a specific user. The product profile is a system of user-oriented multidimensional attribute labels of the product, in which specific attribute values are given for a specific product. For example, as illustrated in FIG. 3, the basic information of the customer has been known before the platform communicates with the customer. On the basis, it needs to define a complete system of financial product-oriented labels for the basic element, i.e., the customer, and give corresponding attribute values. That is, it needs to generate a financial product-oriented user profile of the user. The user profile can include multidimensional attribute information, such as, the population attribute, the credit attribute, the consumption attribute, the risk preference and the household attribute. In addition to the financial product-oriented user profile, it also needs to define a complete system of user-oriented labels for another basic element, i.e., the product, and give corresponding attribute values. That is, it needs to generate a user-oriented product profile of the financial product. As illustrated in FIG. 4, there are multiple categories of the product profile including such as stocks, gold, funds, commodity futures, insurance and bonds, and each product profile includes multidimensional attribute information, such as, risk level attribute, expiry label attribute, product type attribute, and yield attribute.

At step S103, the conversation to be mined is divided into a plurality types of semantic units.

In embodiments of the disclosure, the conversation to be mined obtained at step S101 is divided into multiple types of semantic units for subsequent processing. It is noteworthy that the types respectively correspond to the above-mentioned conversation stages of the conversation to be mined. For example, the active conversation content in the platform conversation content can be identified and then divided based on the conversation content itself and the conversation stages included in the conversation content, while the passive conversation content in the platform conversation content is divided into different types of semantic units according to different questions from the user. In an instance, the conversation to be mined can be divided into two or more types of semantic units, where the two or more types respectively correspond to two or more of the greeting stage, the self-introduction stage, the product/business introduction stage, the answering and guiding stage, and the final conclusion stage. Different types of semantic units represent different conversation stages, and these conversation stages are used to divide the conversation to the mined to obtain the multiple types of semantic units.

At step S104, clustered platform conversation contents are generated by clustering the platform conversation content based on intents of the platform conversation content corresponding to the plurality type of semantic units, the user profile and the product profile, in which the intents of the platform conversation content corresponding to the same type of semantic units are the same or similar.

In embodiments of the disclosure, the semantic units include the intents of the platform conversation content. The intents are different as different conversation stages or problems in the conversation to be mined. That is, the same conversation stage or the same problem corresponds to the same or similar intent, and thus the same type of semantic units correspond to the same or similar intent. According to intents of the platform conversation content corresponding to different types of semantic units after dividing the conversation to be mined at step S104 and the user profile and the product profile corresponding to the conversation to be mined obtained at step S102, the platform conversation content in the conversation to be mined obtained at step S101 is clustered to generate the clustered platform conversation contents. It is noteworthy that portions of the platform conversation content having the same or similar intents, the same or similar user profiles and the same or similar product profiles are clustered together, which means that the semantic units corresponding to the same conversation stage or the same problem of the conversation to be mined are clustered together to obtain the clustered platform conversation contents.

At step S105, a target conversation content is determined from the clustered platform conversation contents based on the clustered platform conversation contents and a conversation content evaluation model.

In embodiments of the disclosure, the conversation content evaluation model is a model used for evaluating and filtering the conversation content. The target conversation content is a set of determined high-quality conversation content. As illustrated in FIG. 5, the target conversation content in the clustered platform conversation contents is determined according to the clustered platform conversation contents generated at step S104 and the conversation content evaluation model, so that the high-quality conversation content obtained in mining the conversation content is the target conversation content. It is understandable by those skilled in the art that the evaluation of the conversation content is carried out on the premise that the two elements, i.e., different users and different products, are aligned respectively to evaluate the quality of different conversation contents. The following factors can be used for evaluating the quality of the conversation contents: work efficiency, the attractiveness of the conversation content, the interest level of the user, and the profile matching degree.

In conclusion, with the method for mining conversation content according to embodiments of the disclosure, the conversation including the platform conversation content is obtained. The user profile and the product profile corresponding to the conversation are obtained. The conversation is divided into different types of semantic units. The clustered platform conversation contents are generated by clustering the platform conversation content based on the intents of the platform conversation content corresponding to the plurality types of semantic units, the user profile and the product profile. The target conversation content in the clustered platform conversation contents is determined based on the clustered platform conversation contents and the conversation content evaluation model. According to the method for mining conversation content of the disclosure, by dividing the conversation to be mined including the platform conversation content according to the user profile and the product profile into the semantic units, by clustering the platform conversation content to generate the clustered platform conversation contents, and by determining the target conversation content based on the clustered platform conversation contents and the conversation content evaluation model, time and labor costs can be reduced, the accuracy of the conversation content mining result can be increased, the adaptability to actual application scenarios can be enhanced, and the working efficiency can be improved.

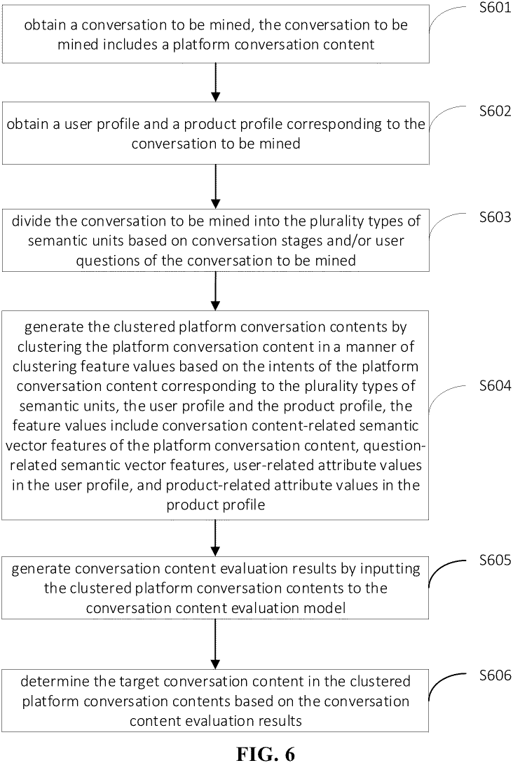

FIG. 6 is a flowchart illustrating a method for mining conversation content according to a second embodiment of the disclosure.

As illustrated in FIG. 6, on the basis of the embodiments of FIG. 1, the method for mining conversation content includes the following.

At step S601, a conversation to be mined is obtained. The conversation to be mined includes a platform conversation content.

At step S602, a user profile and a product profile corresponding to the conversation to be mined are obtained.

For example, the user profile is obtained based on user behaviors and/or chat records corresponding to the conversation to be mined.

It is noteworthy that steps S601-S602 in this embodiment are the same as steps S101-S102 in the above embodiments, which are not repeated here.

Step S103 of “dividing the conversation to be mined into a plurality types of semantic units” in the above embodiments may specifically include the following.

At step S603, the conversation to be mined is divided into the plurality types of semantic units based on conversation stages and/or user questions of the conversation to be mined.

In embodiments of the disclosure, the conversation to be mined is divided based on the conversation stages and/or user questions of the conversation to be mined into the plurality types of semantic units. It is noteworthy that the conversation to be mined can be divided into multiple conversation stages, such as one or more of the greeting stage, the self-introduction stage, the product/business introduction stage, the answering and guiding stage, and the final conclusion stage. These conversation stages and user questions can correspond to different types of semantic units.

The step S104 of “generating the clustered platform conversation contents by clustering the platform conversation content based on the intents of the platform conversation content corresponding to the plurality types of semantic units, the user profile and the product profile” in the above embodiment may include the following.

At step S604, the clustered platform conversation contents are generated by clustering the platform conversation content in a manner of clustering feature values based on the intents of the platform conversation content corresponding to the plurality types of semantic units, the user profile and the product profile. The intents of platform conversation content corresponding to the same type of semantic units are the same or similar.

In embodiments of the disclosure, the feature values include the conversation content-related semantic vector features of the platform conversation content, question-related semantic vector features, user-related attribute values in the user profile, and product-related attribute values in the product profile. The question-related semantic vector features are semantic vector features of the user questions in the passive conversation content. The clustering is performed on the platform conversation content by means of feature value clustering according to the intents of the platform conversation content corresponding to the plurality types of semantic units, the user profile and the product profile to generate the clustered platform conversation contents.

The step S105 of “determining the target conversation content in the clustered platform conversation contents based on the clustered platform conversation contents and the conversation content evaluation model” in the above embodiment may include the following steps S605-S606.

At step S605, conversation content evaluation results are generated by inputting the clustered platform conversation contents to the conversation content evaluation model.

In embodiments of the disclosure, the clustered platform conversation contents generated at step S604 are input to the conversation content evaluation model, to generate corresponding conversation content evaluation results.

At step S606, the target conversation content in the clustered platform conversation contents is determined based on the conversation content evaluation results.

In embodiments of the disclosure, the target conversation content in the clustered platform conversation contents is determined based on the conversation content evaluation results generated at step S605.

In some examples, high-quality conversation contents in the conversation content evaluation results output by the conversation content evaluation model may be ranked in a decedent order based on their confidence levels, and the higher the confidence level, the higher the quality of the conversation content. According to the confidence level, the high-quality conversation content, i.e., the target conversation content, may be determined.

In conclusion, with the method for mining conversation content according to embodiments of the disclosure, the conversation to be mined is obtained, the conversation to be mined includes the platform conversation content. The user profile and the product profile corresponding to the conversation to be mined are obtained. The conversation to be mined is divided into the plurality types of semantic units based on conversation stages and/or user questions of the conversation to be mined. The clustered platform conversation contents are generated by clustering the platform conversation content based on the intents of the platform conversation content corresponding to the plurality types of semantic units, the user profile and the product profile in the manner of clustering the feature values. The feature values include the conversation content-related semantic vector features of the platform conversation content, the question-related semantic vector features, the user-related attribute values in the user profile, and the product-related attribute values in the product profile. The conversation content evaluation results are generated by inputting the clustered platform conversation content to the conversation content evaluation model. The target conversation content in the clustered platform conversation contents is determined based on the conversation content evaluation results. According to the method for mining conversation content of the disclosure, by dividing the conversation to be mined including the platform conversation content based on the user profile and the product profile into the semantic units, by clustering the platform conversation content to generate the clustered platform conversation contents, and by generating the target conversation content based on the clustered platform conversation contents and the conversation content evaluation model, time and labor costs are reduced, the accuracy of the conversation content mining result is increased, the adaptability to actual application scenarios is enhanced, and the working efficiency is improved. Meanwhile, the platform conversation content is clustered by means of feature value clustering, which further increases the accuracy of the conversation content mining result, enhances the adaptability to practical application scenarios, and improves the work efficiency.

Furthermore, the above embodiments further includes performing de-colloquialism on the conversation to be mined.

In embodiments of the disclosure, the de-colloquialism is performed on the conversation to be mined. It is understandable to those skilled in the art that the human conversation is generally unstructured and includes a lot of modal particles, which makes it more difficult to analyze and model the conversation content. Since colloquial words in different contexts are also different, it is not feasible to remove colloquial words only based on the dictionary. For example, in the field of navigation, “from” and “to” are not colloquial words, while in the field of catering, the word “to” in the expression “go to XX restaurant” is a colloquial word.

In a possible implementation, the dictionary and the wordrank model can be used together to perform the de-colloquialism on the conversation to be mined. It is noteworthy that the dictionary includes a summary of common colloquial words, and thus can be used to quickly perform the de-colloquialism on the conversation to be mined. The wordrank model provides supplementary to the dictionary by improving the generalization capabilities of the dictionary. For example, when dealing with the colloquial words that are not included in the dictionary, the wordrank model can make decisions about whether to delete a word that should sometimes be deleted or sometimes not be deleted.

Therefore, the accuracy of identifying the user profile and the product profile is improved by performing the de-colloquialism on the conversation to be mined, thereby improving the accuracy of the subsequent conversation content mining result.

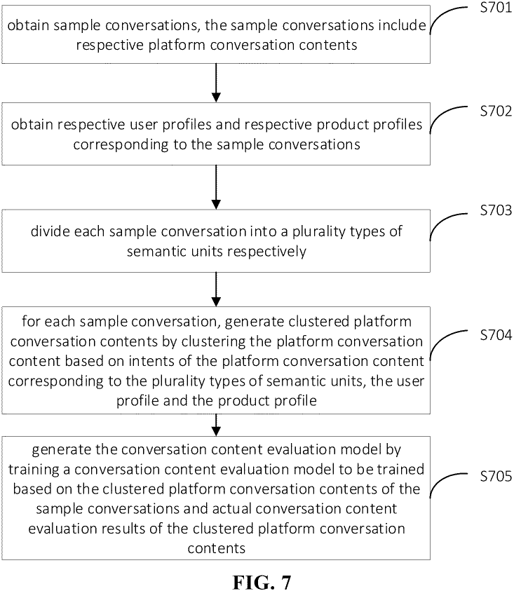

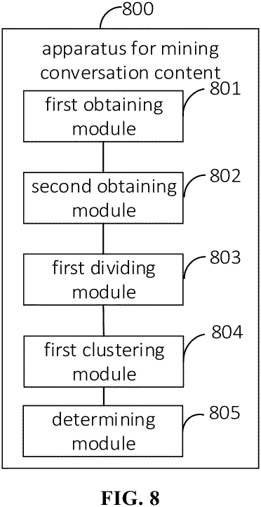

FIG. 7 is a flowchart illustrating a method for generating a conversation content evaluation model according to the first embodiment of the disclosure. As illustrated in FIG. 4, the method for generating a conversation content evaluation model may include the following steps.

At step S701, sample conversations are obtained. The sample conversations include respective platform conversation contents.

The sample conversations are records of conversations provided by the platform used for training the conversation content evaluation model to be trained. For example, by tracking the final result of each customer conversation record, whether the corresponding customer has a positive feedback, whether there is a further communication content, and whether the final order is achieved can be obtained and used as labels to evaluate the quality of the conversation content. Therefore, the platform conversation record having the above labels are used as the sample conversations for training the conversation content evaluation model.

At step S702, respective user profiles and respective product profiles corresponding to the sample conversations are obtained.

For example, the user profile is obtained based on user behaviors and/or chat records corresponding to the sample conversation.

At step S703, for each sample conversation, the sample conversation is divided into a plurality types of semantic units.

In a possible implementation, each sample conversation is divided into the plurality types of semantic units based on conversation stages and/or user questions of the sample conversation.

At step S704, for each sample conversation, clustered platform conversation contents are generated by clustering the platform conversation content based on intents of the platform conversation content corresponding to the plurality types of semantic units, the user profile and the product profile.

In a possible implementation, the clustered platform conversation contents are generated by clustering the platform conversation content in a manner of clustering feature values based on the intents of the platform conversation content corresponding to the plurality types of semantic units, the user profile and the product profile. The feature values include conversation content-related semantic vector features of the platform conversation content, question-related semantic vector features, user-related attribute values in the user profile, and product-related attribute values in the product profile.

At step S705, the conversation content evaluation model to be trained is trained based on the clustered platform conversation contents and actual conversation content evaluation results of the clustered platform conversation contents to obtain the conversation content evaluation model.

In embodiments of the disclosure, the actual conversation content evaluation results of the clustered platform conversation contents are actual evaluation results manually provided by experts by evaluating the quality of the conversation contents. The conversation content evaluation model to be trained is trained according to the clustered platform conversation contents and the actual conversation content evaluation results of the clustered platform conversation contents, to generate the conversation content evaluation model. It is noteworthy that the factors for evaluating the quality of the conversation content includes the work efficiency, the interest level on the conversation content, the interest level of the user, the profile matching degree, or the like. In the technical solution of the disclosure, the model is trained based on a training paradigm of the conversation content evaluation model to be trained + finetune, to achieve a better model training effect. For example, the pre-trained ernie model in the industry can be used as the conversation content evaluation model to be trained, and the platform conversation contents having the labels, such as user feedbacks and orders having been completed, can be used as the finetuned training data for the model training, so as to generate the conversation content evaluation model.

It is noteworthy that the conversation content evaluation model can also be applied in some actual application scenarios where user feedbacks and information in subsequent stages are unavailable for a large amount of platform conversation contents. That is, the conversation content evaluation model can be used to filter the platform conversation contents without any user feedbacks, to obtain the target conversation content conveniently and efficiently.

In a possible implementation, the clustered platform conversation contents are input to the conversation content evaluation model to be trained, to generate the conversation content evaluation results. The conversation content evaluation model to be trained is trained based on the conversation content evaluation results and the actual conversation content evaluation results, to generate the conversation content evaluation model.

Embodiments of the disclosure further include: performing de-colloquialism on the sample conversations.

It is noteworthy that the above description of the implementation of the method for mining conversation content is also applicable to the method for generating a conversation content evaluation model according to the embodiments of the disclosure, and the specific process is not repeated here.

In conclusion, with the method for generating a conversation content evaluation model according to the embodiments of the disclosure, the sample conversations are obtained. Each sample conversation includes a platform conversation content. The user profile and the product profile corresponding to each sample conversation are obtained. Each sample conversation is divided into multiple types of semantic units according to the conversation stages and/or user questions of the sample conversation. Based on the intents of the platform conversation content corresponding to the plurality types of semantic units, the user profile and the product profile, the platform conversation content is clustered in a manner of clustering the feature values to generate the clustered platform conversation contents. The conversation content evaluation model to be trained is trained based on the actual conversation content evaluation results of the clustered platform conversation contents and the clustered platform conversation contents, to generate the conversation content evaluation model. According to the method for generating a conversation content evaluation model of the disclosure, by dividing the sample conversation including the platform conversation content based on the user profile and the product profile into semantic units; by clustering the platform conversation content to generate the clustered platform conversation contents, by training the conversation content evaluation model to be trained according to the clustered platform conversation contents and the actual conversation content evaluation results of the clustered platform conversation contents to generate the conversation content evaluation model, and by using the conversation content evaluation model in mining the conversation content, the time and labor costs can be reduced, the accuracy of the conversation content mining result can be increased, and the work efficiency can be improved.

FIG. 8 is a block diagram illustrating an apparatus for mining conversation content according to the first embodiment of the disclosure.

As illustrated in FIG. 8, the apparatus for mining conversation content 800 according to embodiments of the disclosure includes: a first obtaining module 801, a second obtaining module 802, a first dividing module 803, a first clustering module 804, and a determining module 805.

The first obtaining module 801 is configured to obtain a conversation to be mined. The conversation to be mined includes a platform conversation content.

The second obtaining module 802 is configured to obtain a user profile and a product profile corresponding to the conversation to be mined.

The first dividing module 803 is configured to divide the conversation to be mined into a plurality types of semantic units.

The first clustering module 804 is configured to generate clustered platform conversation contents by clustering the platform conversation content based on intents of the platform conversation content corresponding to the plurality types of semantic units, the user profile and the product profile. Intents of the platform conversation content corresponding to the same type of semantic units are the same or similar.

The determining module 805 is configured to determine a target conversation content in the clustered platform conversation contents based on the clustered platform conversation contents and a conversation content evaluation model.

It is noteworthy that the above explanation of the method for mining conversation content of the embodiment is also applicable to the apparatus for mining conversation content according to the embodiments of the disclosure, and the specific process is not repeated here.

In conclusion, with the apparatus for mining conversation content of the embodiments, the conversation to be mined is obtained. The conversation to be mined includes the platform conversation content. The user profile and the product profile corresponding to the conversation to be mined are obtained. The conversation to be mined is divided into multiple types of semantic units. The platform conversation content is clustered based on the intents of the platform dialogue content corresponding to the plurality types of semantic units, the user profile and the product profile, to generate the clustered platform conversation contents. The target conversation content in the clustered platform conversation contents is determined based on the clustered platform conversation contents and the conversation content evaluation model. With the apparatus for mining conversation content of the disclosure, by dividing the conversation to be mined including the platform conversation content based on the user profile and the product profile into semantic units, by clustering the platform conversation content to generate clustered platform conversation contents, and by determining the target conversation content according to the clustered platform conversation content sand the conversation content evaluation model, the time and labor cost are reduced, the accuracy of the conversation content mining result is increased, and the adaptability to the actual application scenarios is enhanced, and the work efficiency is improved.

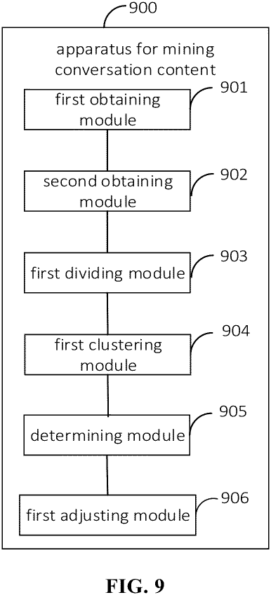

FIG. 9 is a block diagram illustrating an apparatus for mining conversation content according to the second embodiment of the disclosure.

As illustrated in FIG. 9, the apparatus for mining conversation content 900 according to embodiments includes: a first obtaining module 901, a second obtaining module 902, a first dividing module 903, a first clustering module 904, and a determining module 905.

The first obtaining module 901 has the same structure and function as the first obtaining module 801 in the previous embodiments. The second obtaining module 902 has the same structure and function as the second obtaining module 802 in the previous embodiments. The first dividing module 903 has the same structure and function as the first dividing module 803 in the previous embodiments. The first clustering module 904 has the same structure and function as the first clustering module 804 in the previous embodiments. The determining module 905 has the same structure and function as the determining module 805 in the previous embodiments.

The second obtaining module 902 includes: an obtaining unit configured to obtain the user profile based on user behaviors and/or chat records corresponding to the conversation to be mined.

The first dividing module 903 includes: a dividing unit configured to divide the conversation to be mined into the plurality types of semantic units based on conversation stages and/or user questions of the conversation to be mined.

The first clustering module 904 includes: a clustering unit configured to generate the clustered platform conversation contents by clustering the platform conversation content in a manner of clustering feature values based on the intents of the platform conversation content corresponding to the plurality types of semantic units, the user profile and the product profile. The feature values include conversation content-related semantic vector features of the platform conversation content, question-related semantic vector features, user-related attribute values in the user profile, and product-related attribute values in the product profile.

The determining module 905 includes: an inputting unit configured to generate conversation content evaluation results by inputting the clustered platform conversation contents to the conversation content evaluation model; and a determining unit configured to determine the target conversation content in the clustered platform conversation contents based on the conversation content evaluation results.

The apparatus 900 further includes: a first adjusting module 906 configured to perform de-colloquialism on the conversation to be mined.

It is noteworthy that the above explanation of the method for mining conversation content of the embodiment is also applicable to the apparatus for mining conversation content according to the embodiments of the disclosure, and the specific process is not repeated here.

In conclusion, with the apparatus for mining conversation content of the embodiments, the conversation to be mined is obtained, the conversation to be mined includes the platform conversation content. The user profile and the product profile corresponding to the conversation to be mined are obtained. The conversation to be mined is divided into multiple types of semantic units based on the conversation stages and/or user questions of the conversation to be mined. The platform conversation content is clustered based on the intents of the platform conversation content corresponding to the multiple types of semantic units, the user profile and the product profile by means of feature value clustering, to generate the clustered platform conversation contents. The feature values include the conversation content-related semantic vector features of the platform conversation content, the question-related semantic vector features, the user-related attribute values in the user profile, and the product-related attribute values in the product profile. The conversation content evaluation results are generated by inputting the clustered platform conversation contents to the conversation content evaluation model. The target conversation content in the clustered platform conversation contents is determined based on the conversation content evaluation results. With the apparatus for mining conversation content, by dividing the conversation to be mined including the platform conversation content based on the user profile and the product profile into the semantic units, by clustering the platform conversation content to generate the clustered platform conversation contents, and by generating the target conversation content based on the clustered platform conversation contents and the conversation content evaluation model, time and labor costs are reduced, the accuracy of the conversation content mining result is increased, the adaptability to actual application scenarios is enhanced, and the working efficiency is improved. Meanwhile, the platform conversation content is clustered by means of feature value clustering, which further increases the accuracy of the conversation content mining result, enhances the adaptability to practical application scenarios, and improves the work efficiency.

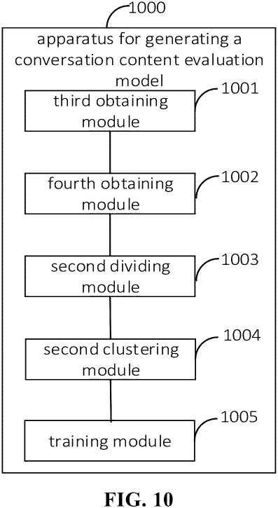

FIG. 10 is a block diagram illustrating an apparatus for generating a conversation content evaluation model according to the first embodiment of the disclosure.

As illustrated in FIG. 10, the apparatus 1000 for generating a conversation content evaluation model according to the embodiments includes: a third obtaining module 1001, a fourth obtaining module 1002, a second dividing module 1003, a second clustering module 1004, and a training module 1005.

The third obtaining module 1001 is configured to obtain sample conversations. The sample conversations include respective platform conversation contents.

The fourth obtaining module 1002 is configured to obtain respective user profiles and respective product profiles corresponding to the sample conversations.

The second dividing module 1003 is configured to divide each sample conversation into a plurality types of semantic units respectively.

The second clustering module 1004 is configured to for each sample conversation, generate clustered platform conversation contents by clustering the platform conversation content based on intents of the platform conversation content corresponding to the plurality types of semantic units, the user profile and the product profile.

The training module 1005 is configured to generate the conversation content evaluation model by training a conversation content evaluation model to be trained based on the clustered platform conversation contents and actual conversation content evaluation results of the clustered platform conversation contents.

It is noteworthy that the above explanation of the method for generating a conversation content evaluation model of the embodiment is also applicable to the apparatus for generating a conversation content evaluation model according to the embodiments of the disclosure, and the specific process is not repeated here.

In conclusion, with the apparatus for generating a conversation content evaluation model according to the embodiments of the disclosure, the sample conversations are obtained. Each sample conversation includes a platform conversation content. The user profile and the product profile corresponding to each sample conversation are obtained. Each sample conversation is divided into multiple types of semantic units. Based on the intents of the platform conversation content corresponding to the plurality types of semantic units, the user profile and the product profile, the platform conversation content is clustered to generate the clustered platform conversation contents. The conversation content evaluation model to be trained is trained based on the actual conversation content evaluation results of the clustered platform conversation contents and the clustered platform conversation contents, to generate the conversation content evaluation model. According to the apparatus for generating a conversation content evaluation model of the disclosure, by dividing the sample conversation including the platform conversation content based on the user profile and the product profile into semantic units; by clustering the platform conversation content to generate the clustered platform conversation contents, by training the conversation content evaluation model to be trained according to the clustered platform conversation contents and the actual conversation content evaluation results of the clustered platform conversation contents to generate the conversation content evaluation model, and by using the conversation content evaluation model in mining the conversation content, the time and labor costs can be reduced, the accuracy of the conversation content mining result can be increased, and the work efficiency can be improved.

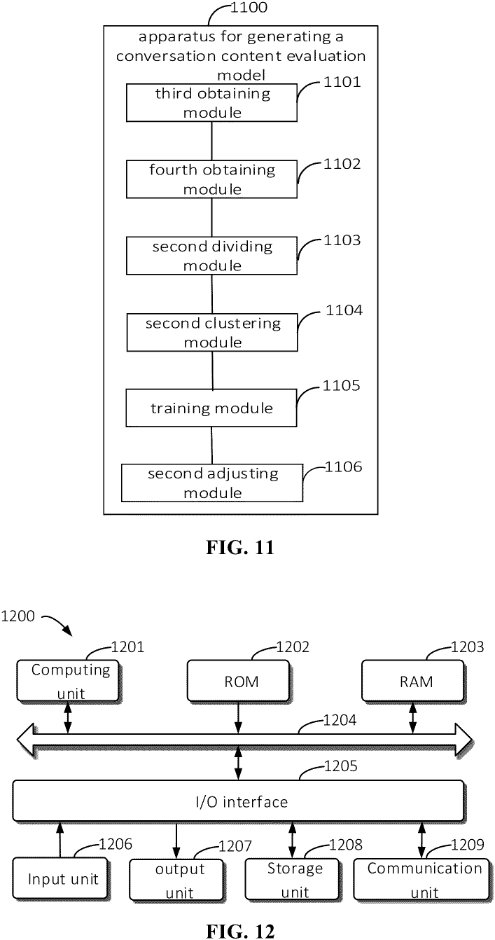

FIG. 11 is a block diagram illustrating an apparatus for generating a conversation content evaluation model according to the second embodiment of the disclosure.

As illustrated in FIG. 11, the apparatus 1100 for generating a conversation content evaluation model according to the embodiments includes: a third obtaining module 1101, a fourth obtaining module 1102, a second dividing module 1103, a second clustering module 1104, and a training module 1105.

The third obtaining module 1101 has the same structure and function as the third obtaining module 1001 in the previous embodiments. The fourth obtaining module 1102 has the same structure and function as the fourth obtaining module 1002 in the previous embodiments. The second dividing module 1103 has the same structure and function as the second dividing module 1003 in the previous embodiments. The second clustering module 1104 has the same structure and function as the second clustering module 1004 in the previous embodiments. The training module 1105 has the same structure and function as the training module 1005 in the previous embodiments.

The fourth obtaining module 1102 includes: an obtaining unit configured to obtain the user profile based on user behaviors and/or chat records corresponding to each sample conversation.

The second dividing module 1103 includes: a dividing unit configured to divide each sample conversations into the plurality types of semantic units based on conversation stages and/or user questions of the sample conversation.

The second clustering module 1104 includes: a clustering unit configured to generate the clustered platform conversation contents by clustering the platform conversation content in a manner of clustering feature values based on the intents of the platform conversation content corresponding to the plurality types of semantic units, the user profile and the product profile. The feature values include conversation content-related semantic vector features of the platform conversation content, question-related semantic vector features, user-related attribute values in the user profile, and product-related attribute values in the product profile.

The training module 1105 includes: an input unit configured to generate conversation content evaluation results by inputting the clustered platform conversation contents to the conversation content evaluation model to be trained; and a training unit configured to generate the conversation content evaluation model by training the conversation content evaluation model to be trained based on the conversation content evaluation results and the actual conversation content evaluation results.

The apparatus 1100 further includes: a second adjusting module 1106 configured to perform de-colloquialism on the conversation samples.

It is noteworthy that the above explanation of the method for generating a conversation content evaluation model of the embodiments is also applicable to the apparatus for generating a conversation content evaluation model of the embodiments of the disclosure, and the specific process is not repeated here.

In conclusion, with the apparatus for generating a conversation content evaluation model according to the embodiments of the disclosure, the sample conversations are obtained. Each sample conversation includes a platform conversation content. The user profile and the product profile corresponding to each sample conversation are obtained. Each sample conversation is divided into multiple types of semantic units according to the conversation stages and/or user questions of the sample conversation. Based on the intents of the platform conversation content corresponding to the plurality types of semantic units, the user profile and the product profile, the platform conversation content is clustered in a manner of clustering the feature values to generate the clustered platform conversation contents. The conversation content evaluation model to be trained is trained based on the actual conversation content evaluation results of the clustered platform conversation contents and the clustered platform conversation contents, to generate the conversation content evaluation model. According to the apparatus for generating a conversation content evaluation model of the disclosure, by dividing the sample conversation including the platform conversation content based on the user profile and the product profile into semantic units; by clustering the platform conversation content to generate the clustered platform conversation contents, by training the conversation content evaluation model to be trained according to the clustered platform conversation contents and the actual conversation content evaluation results of the clustered platform conversation contents to generate the conversation content evaluation model, and by using the conversation content evaluation model in mining the conversation content, the time and labor costs can be reduced, the accuracy of the conversation content mining result can be increased, and the work efficiency can be improved.

The collection, storage, use, processing, transmission, provision and disclosure of the user’s personal information involved in the technical solutions of this disclosure are in accordance with the provisions of relevant laws and regulations and are not contrary to public order and good morals.

According to the embodiments of the disclosure, the disclosure also provides an electronic device, a readable storage medium and a computer program product.

FIG. 12 is a block diagram illustrating an example electronic device 1200 used to implement the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processors, cellular phones, smart phones, wearable devices, and other similar computing devices. The components shown here, their connections and relations, and their functions are merely examples, and are not intended to limit the implementation of the disclosure described and/or required herein.

As illustrated in FIG. 12, the device 1200 includes a computing unit 1201 performing various appropriate actions and processes based on computer programs stored in a Read-Only Memory (ROM) 1202 or computer programs loaded from a storage unit 1208 to a Random Access Memory (RAM) 1203. In the RAM 1203, various programs and data required for the operation of the device 1200 are stored. The computing unit 1201, the ROM 1202, and the RAM 1203 are connected to each other through a bus 1204. An input/output (I/O) interface 1205 is also connected to the bus 1204.

Components in the device 1200 are connected to the I/O interface 1205, including: an input unit 1206, such as a keyboard, a mouse; an output unit 1207, such as various types of displays, speakers; a storage unit 1208, such as a disk, an optical disk; and a communication unit 1209, such as network cards, modems, and wireless communication transceivers. The communication unit 1209 allows the device 1200 to exchange information/data with other devices through a computer network such as the Internet and/or various telecommunication networks.

The computing unit 1201 may be various general-purpose and/or dedicated processing components with processing and computing capabilities. Some examples of the computing unit 1201 include, but are not limited to, a Central Processing Unit (CPU), a Graphics Processing Unit (GPU), various dedicated AI computing chips, various computing units that run ML model algorithms, and a Digital Signal Processor (DSP), and any appropriate processor, controller and microcontroller. The computing unit 1201 executes the various methods and processes described above, such as the method for mining conversation content shown in FIG. 1 to FIG. 6 or the method for generating a conversation content evaluation model shown in FIG. 7. For example, in some embodiments, the method for mining conversation content or the method for generating a conversation content evaluation model may be implemented as computer software programs, which are tangibly contained in a machine-readable medium, such as the storage unit 1208. In some embodiments, part or all of the computer programs may be loaded and/or installed on the device 1200 via the ROM 1202 and/or the communication unit 1209. When the computer programs are loaded on the RAM 1203 and executed by the computing unit 1201, one or more steps of the method for mining conversation content or the method for generating a conversation content evaluation model described above may be executed. Alternatively, in other embodiments, the computing unit 1201 may be configured to perform the method for mining conversation content or the method for generating a conversation content evaluation model in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, RAMs, ROMs, Electrically Programmable Read-Only-Memories (EPROMs), flash memories, fiber optics, Compact Disc Read-Only Memories (CD-ROMs), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: a Local Area Network (LAN), a Wide Area Network (WAN), the Internet and a block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host. The server is a host product in a cloud computing service system to solve difficult management and poor business expansion of traditional physical hosting and Virtual Private Server (VPS) services. The server may be a server of a distributed system, or a server combined with a block-chain.

According to the embodiments of the disclosure, the disclosure also provides a computer program product including computer programs. When the computer programs are executed by a processor, the steps of the method for mining conversation content according to the above-described embodiments of the disclosure or the method for generating a conversation content evaluation model according to the above-described embodiments of the disclosure are implemented.

It is understandable that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

What is claimed is:

1. A method for mining conversation content, comprising:
obtaining a conversation to be mined, wherein the conversation to be mined comprises a platform conversation content;
obtaining a user profile and a product profile corresponding to the conversation to be mined;
dividing the conversation to be mined into a plurality types of semantic units;
generating clustered platform conversation contents by clustering the platform conversation content based on intents of the platform conversation content corresponding the plurality types of semantic units, the user profile and the product profile, wherein intents of the platform conversation content corresponding to the same type of semantic units are the same or similar; and
determining a target conversation content in the clustered platform conversation contents based on the clustered platform conversation contents and a conversation content evaluation model.

2. The method of claim 1, wherein obtaining the user profile corresponding to the conversation to be mined comprises:
obtaining the user profile based on at least one of user behaviors or user chat records corresponding to the conversation to be mined.

3. The method of claim 1, wherein dividing the conversation to be mined into the plurality types of semantic units comprises:
dividing the conversation to be mined into the plurality types of semantic units based on at least one of conversation stages or user questions of the conversation to be mined.

4. The method of claim 1, wherein generating the clustered platform conversation contents by clustering the platform conversation content based on the intents of the platform conversation content corresponding to the plurality types of semantic units, the user profile and the product profile comprises:
generating the clustered platform conversation contents by clustering the platform conversation content in a manner of clustering feature values based on the intents of the platform conversation content, the user profile and the product profile, wherein the feature values comprise conversation content-related semantic vector features of the platform conversation content, question-related semantic vector features, user-related attribute values in the user profile, and product-related attribute values in the product profile.

5. The method of claim 1, wherein determining the target conversation content in the clustered platform conversation contents based on the clustered platform conversation contents and the conversation content evaluation model comprises:
generating conversation content evaluation results by inputting the clustered platform conversation contents to the conversation content evaluation model; and
determining the target conversation content in the clustered platform conversation contents based on the conversation content evaluation results.

6. The method of claim 1, further comprising:
performing de-colloquialism on the conversation to be mined.

7. A method for generating a conversation content evaluation model, comprising:
obtaining sample conversations, wherein the sample conversations comprise respective platform conversation contents;
obtaining respective user profiles and respective product profiles corresponding to the sample conversations;
dividing each sample conversation into a plurality types of semantic units respectively;
for each sample conversation, generating clustered platform conversation contents by clustering the platform conversation content of the sample conversation based on intents of the platform conversation content corresponding to the plurality types of semantic units, the respective user profile and the respective product profile, wherein intents of the platform conversation content corresponding to the same type of semantic units are the same or similar; and
generating the conversation content evaluation model by training a conversation content evaluation model to be trained based on the clustered platform conversation contents of the sample conversations and respective actual conversation content evaluation results of the clustered platform conversation contents.

8. The method of claim 7, wherein obtaining the respective user profiles corresponding to the sample conversations comprises:
for each sample conversation, obtaining the respective user profile based on at least one of user behaviors or user chat records corresponding to the sample conversation.

9. The method of claim 7, wherein dividing each sample conversations into the plurality types of semantic units respectively comprises:
for each sample conversation, dividing the sample conversation into the plurality types of semantic units based on at least one of conversation stages or user questions of the sample conversation.

10. The method of claim 7, wherein generating the clustered platform conversation contents by clustering the platform conversation content of the sample conversation based on the intents of the platform conversation content corresponding to the plurality types of semantic units, the respective user profile and the respective product profile comprises:
generating the clustered platform conversation contents by clustering the platform conversation content in a manner of clustering feature values based on the intents of the platform conversation content, the respective user profile and the respective product profile, wherein the feature values comprise conversation content-related semantic vector features of the platform conversation content, question-related semantic vector features, user-related attribute values in the respective user profile, and product-related attribute values in the respective product profile.

11. The method of claim 7, wherein generating the conversation content evaluation model by training the conversation content evaluation model to be trained based on the clustered platform conversation contents of the sample conversations and the respective actual conversation content evaluation results of the clustered platform conversation contents comprises:
generating conversation content evaluation results by inputting the clustered platform conversation contents of the sample conversations to the conversation content evaluation model to be trained; and
generating the conversation content evaluation model by training the conversation content evaluation model to be trained based on the conversation content evaluation results and the respective actual conversation content evaluation results.

12. The method of claim 7, further comprising:
performing de-colloquialism on the sample conversations.

13. An electronic device, comprising:
at least one processor; and
a memory communicatively connected to the at least one processor;
wherein the memory stores instructions executable by the at least one processor, when the instructions are executed by the at least one processor, the at least one processor is configured to:
obtain a conversation to be mined, wherein the conversation to be mined comprises a platform conversation content;
obtain a user profile and a product profile corresponding to the conversation to be mined;
divide the conversation to be mined into a plurality types of semantic units;
generate clustered platform conversation contents by clustering the platform conversation content based on intents of the platform conversation content corresponding the plurality types of semantic units, the user profile and the product profile, wherein intents of the platform conversation content corresponding to the same type of semantic units are the same or similar; and
determine a target conversation content in the clustered platform conversation contents based on the clustered platform conversation contents and a conversation content evaluation model.

14. The electronic device of claim 13, wherein the at least one processor is configured to:
obtain the user profile based on at least one of user behaviors or user chat records corresponding to the conversation to be mined.

15. The electronic device of claim 13, wherein the at least one processor is configured to:
divide the conversation to be mined into the plurality types of semantic units based on at least one of conversation stages or user questions of the conversation to be mined.

16. The electronic device of claim 13, wherein the at least one processor is configured to:
generate the clustered platform conversation contents by clustering the platform conversation content in a manner of clustering feature values based on the intents of the platform conversation content, the user profile and the product profile, wherein the feature values comprise conversation content-related semantic vector features of the platform conversation content, question-related semantic vector features, user-related attribute values in the user profile, and product-related attribute values in the product profile.

17. The electronic device of claim 13, wherein the at least one processor is configured to:
generate conversation content evaluation results by inputting the clustered platform conversation contents to the conversation content evaluation model; and
determine the target conversation content in the clustered platform conversation contents based on the conversation content evaluation results.

18. The electronic device of claim 13, wherein the at least one processor is further configured to:
perform de-colloquialism on the conversation to be mined.

19. An electronic device, comprising:
at least one processor; and
a memory communicatively connected to the at least one processor;
wherein the memory stores instructions executable by the at least one processor, when the instructions are executed by the at least one processor, the at least one processor is configured to perform the method of claim 7.
